(19) United States
(12) Patent Application Publication
(10) Pub. No.: US 2016/0251981 A1
(43) Pub. Date: Sep. 1, 2016

(54) GAS TURBINE

(71) Applicant: MITSUBISHI HITACHI POWER SYSTEMS, LTD., Yokohama-shi, Kanagawa (JP)

(72) Inventor: Shinya HASHIMOTO, Tokyo (JP)

(21) Appl. No.: 15/028,564

(22) PCT Filed: Sep. 8, 2014
(86) PCT No.: PCT/JP2014/073698

§ 371 Date: Apr. 11, 2016

(30) Foreign Application Priority Data
Oct. 15, 2013 (JP) 2013-214971

(51) Int. Cl. F01D 25/12; F02C 7/18; F01D 5/02; F02C 9/18; F01D 25/10; F01D 25/24; F02C 7/24; F02C 3/04; F01D 9/04

(52) U.S. Cl. CPC F01D 25/12; F02C 3/04; F02C 7/18; F01D 5/02; F01D 9/041; F01D 25/10; F01D 25/24; F02C 7/24; F02C 9/18; F05D 2220/32; F05D 2240/35; F05D 2260/231

(57) ABSTRACT

There is provided a gas turbine including: a blade ring which is coupled on the inner circumference of a turbine casing so as to define an annular first cavity; a plurality of heat shield rings coupled on the inner circumference of the blade ring; a plurality of ring segments coupled on the inner circumference of the plurality of heat shield rings; a plurality of blade bodies fixed on the outer circumference of a rotor and disposed so as to radially face the ring segments; a plurality of vane bodies of which an outer shroud is fixed on the heat shield rings between the plurality of blade bodies so as to define an annular second cavity; a second cooling air supply channel; a first cooling air supply channel; and a cooling air discharge channel which discharges the cooling air from the first cavity.

### TECHNICAL FIELD

The present invention relates to, for example, a gas turbine in which fuel is supplied to and combusted in high-temperature high-pressure compressed air and the generated combustion gas is supplied to a turbine to produce rotary power.

### BACKGROUND ART

A common gas turbine is composed of a compressor, a combustor, and a turbine. The compressor compresses air taken in through an air inlet to turn the air into high-temperature high-pressure compressed air. The combustor supplies fuel to this compressed air and combusts the fuel to produce high-temperature high-pressure combustion gas. The turbine is driven by this combustion gas, and drives a generator which is coaxially coupled to the turbine.

The turbine of such a gas turbine has pluralities of vanes and blades installed inside a casing alternately along the flow direction of combustion gas, and the combustion gas generated in the combustor passes through the pluralities of vanes and blades and thereby drives the rotor to rotate, which in turn drives the generator coupled to this rotor.

A space surrounded by an outer shroud and an inner shroud constituting a part of the vanes, blade platforms, and ring segments forms a combustion gas flow passage (gas path) in which the vanes and the blades are disposed and through which high-temperature combustion gas flows. The blade platforms are mounted in a ring shape around the rotation axis, while the vanes and the ring segments are disposed in a ring shape around the rotation axis and supported on the casing side through heat shield rings and a blade ring.

The blade ring is divided into halves around the rotor and disposed in a ring shape. The heat shield rings are disposed on the inner circumferential side of the blade ring and supported by the blade ring. The vanes and the ring segments are disposed on the radially inner side of the heat shield rings and supported by the heat shield rings.

The turbine has a structure such that the clearance between the tip of the blade and the inner circumferential surface of the ring segment is reduced as far as possible without causing interference therebetween in order to suppress a clearance flow of combustion gas and prevent deterioration of the gas turbine performance.

Cooling air extracted from an intermediate stage of the compressor is supplied to the turbine casing, and the cooling air is supplied through the blade ring to the vanes and the ring segments to protect the components around the blade ring (the ring segments, the heat shield rings, etc.) from thermal damage due to combustion gas. Since the cooling air is finally discharged into the combustion gas flowing through the gas path, relatively high-pressure bleed air is typically used as cooling air.

Examples of such a gas turbine include the one described in Patent Literature 1.

### CITATION LIST

### Patent Literature

Patent Literature 1: Japanese Patent Laid-Open No. 7-54669

### SUMMARY OF INVENTION

### Technical Problems

In the turbine of the conventional gas turbine described above, for example, during hot start, a tip portion of each blade elongates toward the radially outer side as the blade rotates at a high speed, while the components around the blade ring on the casing side temporarily contract toward the radially inner side by being cooled with low-temperature cooling air. In this case, during the period after start of the gas turbine until it reaches rated operation, a pinch point (minimum clearance) occurs at which the clearance between the tip of the blade and the inner wall surface of the ring segment constituting a part of the gas path decreases temporarily. It is therefore necessary to secure a predetermined clearance such that the tip of the blade and the inner wall surface of the ring segment do not come into contact with each other even at the pinch point. On the other hand, when the gas turbine reaches steady operation, the clearance between the tip of the blade and the inner wall surface of the ring segment becomes excessively large, so that the driving force recovery efficiency of the turbine decreases and the performance of the gas turbine itself deteriorates.

Moreover, in the turbine described in Patent Literature 1, since relatively high-temperature bleed air is supplied from the compressor to the blade ring, it is difficult to sufficiently cool the blade ring and the components around the blade ring, and the above-mentioned clearance can be reduced only to a limited extent. To lower the temperature of bleed air, it is necessary to cool the bleed air, but cooling the bleed air leads to heat loss, causing deterioration of the gas turbine performance.

Having been devised to solve the above problems, the present invention aims to provide a gas turbine in which a proper amount of clearance is secured between the turbine casing side and the blades to enhance the performance.

### Solution to Problems

A gas turbine of the present invention for achieving the above object includes: a compressor which compresses air; a combustor which mixes compressed air compressed by the compressor and fuel and combusts the fuel; a turbine which produces rotary power from combustion gas generated by the combustor; and a rotating shaft which is driven by the combustion gas to rotate around a rotation axis, wherein the turbine includes: a turbine casing forming a ring shape around the rotation axis; a blade ring which forms a ring shape around the rotation axis and is supported on the inner circumference of the turbine casing so as to define a ring-shaped first cavity; a plurality of heat shield rings which form a ring shape around the rotation axis and are supported on the inner circumference of the blade ring at predetermined intervals in the axial direction; a plurality of ring segments which form a ring shape around the rotation axis and are supported on the inner circumference of the plurality of heat shield rings; a plurality of blade bodies which are fixed on the outer circumference of the rotating shaft at predetermined intervals in the axial direction and disposed so as to radially face the ring segments; a plurality of vane bodies of which a shroud forming a ring shape around the rotation axis between the plurality of blade bodies is fixed on the adjacent heat shield rings so as to define a ring-shaped second cavity; a second cooling air supply channel which supplies a part of the compressed air compressed by the compressor to the second cavity; a first cooling air supply channel which supplies cooling air having a lower temperature than the compressed air compressed by the compressor to the first cavity; and a cooling air discharge channel which discharges the cooling air from the first cavity.

Accordingly, a part of the compressed air is extracted from the compressor, and the extracted compressed air is supplied through the second cooling air supply channel to the second cavity, while cooling air having a lower temperature than this compressed air is supplied through the first cooling air supply channel to the first cavity, and the cooling air is discharged from the first cavity through the cooling air discharge channel. Thus, as the heat shield rings are cooled by the compressed air from the compressor and the blade ring is cooled by the cooling air from the radially inner side and outer side, the blade ring and the heat shield rings do not shift significantly under the heat of the combustion gas. It is therefore possible to suppress a decrease in driving force recovery efficiency of the turbine and enhance the gas turbine performance by securing a proper amount of clearance between the ring segment and the blade.

A gas turbine of the present invention includes: a compressor which compresses air; a combustor which mixes compressed air compressed by the compressor and fuel and combusts the fuel; a turbine which produces rotary power from combustion gas generated by the combustor; and a rotating shaft which is driven by the combustion gas to rotate around a rotation axis, wherein the turbine includes: a turbine casing forming a ring shape around the rotation axis; a blade ring which forms a ring shape around the rotation axis and is coupled on the inner circumference of the turbine casing so as to define an annular first cavity; a plurality of heat shield rings which form a ring shape around the rotation axis and are coupled on the inner circumference of the blade ring at predetermined intervals in the axial direction; a plurality of ring segments which form a ring shape around the rotation axis and are coupled on the inner circumference of the plurality of heat shield rings; a plurality of blade bodies which are fixed on the outer circumference of the rotating shaft at predetermined intervals in the axial direction and disposed so as to radially face the ring segments; a plurality of vane bodies of which a shroud forming a ring shape around the rotation axis between the plurality of blade bodies is fixed on the adjacent heat shield rings so as to define an annular second cavity; a second cooling air supply channel which supplies a part of the compressed air compressed by the compressor to the second cavity; a cooling air flow passage which is provided inside the blade ring and of which one end communicates with the first cavity; a first cooling air supply channel which supplies cooling air having a lower temperature than the compressed air compressed by the compressor to one of the other end of the cooling air flow passage and the first cavity; and a cooling air discharge channel which discharges the cooling air from the other one of the other end of the cooling air flow passage and the first cavity.

Accordingly, since the cooling air flow passage is provided inside the blade ring, the blade ring is further cooled, which makes it easier to control the clearance between the tip of the blade and the ring segment.

In the gas turbine of the present invention, a heat insulation/shield member is provided on the inner circumferential surface of the blade ring.

Accordingly, as heat input from the second cavity into the blade ring is blocked by the heat insulation/shield member, the blade ring can be further cooled.

In the gas turbine of the present invention, the cooling air flow passage has a plurality of manifolds disposed at predetermined intervals in the axial direction of the rotating shaft, and coupling paths coupling the plurality of manifolds in series.

Accordingly, as cooling air flows among the plurality of manifolds through the coupling paths inside the blade ring, the blade ring can be cooled efficiently.

In the gas turbine of the present invention, the blade ring has a cylindrical part extending along the axial direction of the rotating shaft, and a first outer circumferential flange and a second outer circumferential flange provided respectively at both ends of the cylindrical part; the plurality of manifolds are formed as cavities in the first outer circumferential flange and the second outer circumferential flange; and the coupling paths are formed as a plurality of communication holes in the cylindrical part.

Accordingly, cooling air flows among the plurality of manifolds through the plurality of communication holes serving as the coupling paths, and as the cooling air flows throughout the interior of the blade ring, the blade ring can be cooled efficiently.

In the gas turbine of the present invention, the first cooling air supply channel supplies atmospheric air suctioned by means of a blower.

Accordingly, since the first cooling air supply channel supplies atmospheric air, it is possible to easily supply the cooling air and cool the blade ring in a simple configuration.

In the gas turbine of the present invention, the heat shield ring is composed of a material having a higher thermal expansion rate than the blade ring.

Accordingly, since the heat shield ring is heated by the combustion gas and thermally expands, the clearance between the ring segment and the blade can be set to a small amount.

In the gas turbine of the present invention, the first cooling air supply channel includes a heating device which heats the cooling air.

Accordingly, the clearance between the tip of the blade and the ring segment during a stage from start of the gas turbine until it reaches rated load operation can be reduced, so that deterioration of the gas turbine performance can be suppressed.

In the gas turbine of the present invention, the cooling air discharge channel introduces the cooling air discharged from the first cavity into an exhaust cooling system.

Accordingly, it is possible to effectively utilize the cooling air by introducing the cooling air having cooled the blade ring through the cooling air discharge channel into the exhaust cooling system.

### Advantageous Effects of Invention

According to the gas turbine of the present invention, the cooling air having a lower temperature than the cooling air supplied to the second cavity defined on the inner side of the blade ring is supplied to the first cavity defined on the outer side of the blade ring. Thus, since the blade ring is kept in contact with the low-temperature cooling air throughout the period from start of the gas turbine until it reaches rated operation, the blade ring itself does not shift significantly. Accordingly, by being able to set the clearance between the ring segment and the blade during rated operation to a proper amount, it is possible to suppress a decrease in driving force recovery efficiency of the turbine and enhance the gas turbine performance.

### BRIEF DESCRIPTION OF DRAWINGS

FIG. 1 is a cross-sectional view showing the vicinity of a combustor in a gas turbine of an embodiment.

FIG. 2 is a cross-sectional view showing the vicinity of a blade ring of a turbine.

FIG. 3 is a cross-sectional view of the vicinity of a blade ring of a turbine showing a modified example of the embodiment.

FIG. 4 is a view of a first cooling air supply channel showing a modified example of the embodiment.

FIG. 5 is a graph showing the behavior of a clearance between constituent members of the turbine during hot start of the gas turbine.

FIG. 6 is a graph showing the behavior of the clearance between the constituent members of the turbine during cold start of the gas turbine.

FIG. 7 is a schematic view showing the overall configuration of the gas turbine.

### DESCRIPTION OF EMBODIMENT

In the following, a preferred embodiment of a gas turbine according to the present invention will be described in detail with reference to the accompanying drawings. The present invention is not limited by this embodiment, and if there are a plurality of embodiments, the present invention also includes configurations which combine the embodiments.

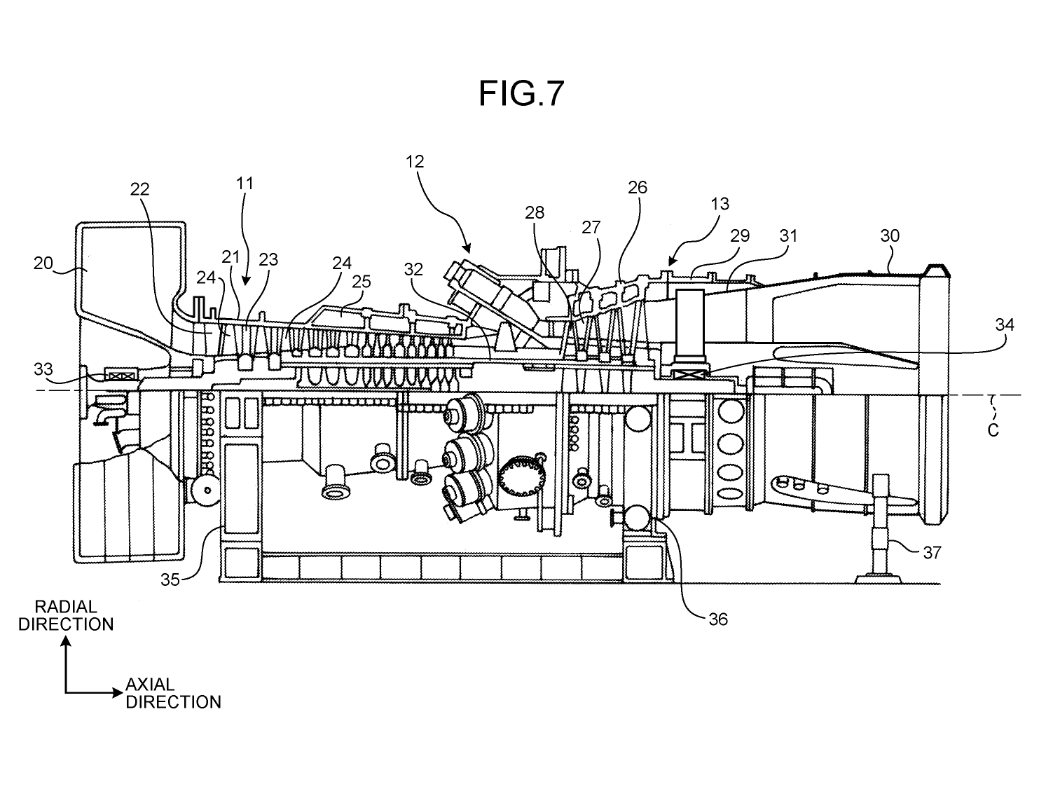

FIG. 7 is a schematic view showing the overall configuration of the gas turbine of this embodiment.

As shown in FIG. 7, the gas turbine of this embodiment is composed of a compressor 11, combustors 12, and a turbine 13. This gas turbine can generate electric power with a generator (not shown) coaxially coupled thereto.

The compressor 11 has an air inlet 20 through which air is taken in. Inside a compressor casing 21, an inlet guide vane (IGV) 22 is installed and a plurality of vanes 23 and a plurality of blades 24 are installed alternately in an air flow direction (the axial direction of a rotor 32 to be described later), and a bleed air chamber 25 is provided on the outer side of the compressor casing 21. This compressor 11 compresses air taken in through the air inlet 20 to turn the air into high-temperature high-pressure compressed air.

The combustor 12 supplies fuel to the high-temperature high-pressure compressed air compressed in the compressor 11 and combusts the fuel to generate combustion gas. The turbine 13 has a plurality of vanes 27 and a plurality of blades 28 installed alternately in the flow direction of the combustion gas (the axial direction of the rotor 32 to be described later) inside a turbine casing 26. On the downstream side of this turbine casing 26, an exhaust chamber 30 is installed through an exhaust casing 29, and the exhaust chamber 30 has an exhaust diffuser 31 connected with the turbine 13. This turbine is driven by the combustion gas from the combustor 12, and drives the generator coaxially coupled to the turbine.

The rotor (rotating shaft) 32 is disposed through the compressor 11, the combustors 12, and the turbine 13 so as to penetrate a center part of the exhaust chamber 30. One end of the rotor 32 on the side of the compressor 11 is rotatably supported by a bearing 33, and the other end on the side of the exhaust chamber 30 is rotatably supported by a bearing 34. In the compressor 11, a plurality of discs each having the blades 24 mounted thereon are stacked and fixed on the rotor 32, and in the turbine 13, a plurality of discs each having the blades 28 mounted thereon are stacked and fixed on the rotor 32, and the driving shaft of the generator is coupled to the end of the rotor 32 on the side of the exhaust chamber 30.

In this gas turbine, the compressor casing 21 of the compressor 11 is supported by a leg 35, the turbine casing 26 of the turbine 13 is supported by a leg 36, and the exhaust chamber 30 is supported by a leg 37.

Accordingly, in the compressor 11, air taken in through the air inlet 20 is compressed and turned into high-temperature high-pressure compressed air by passing through the inlet guide vane 22 and the pluralities of vanes 23 and blades 24. In the combustor 12, a predetermined fuel is supplied to and combusted in this compressed air. In the turbine 13, high-temperature high-pressure combustion gas G generated in the combustor 12 passes through the pluralities of vanes 27 and blades 28 of the turbine 13 and thereby drives the rotor 32 to rotate, which in turn drives the generator coupled to the rotor 32. Meanwhile, the combustion gas is released into the atmosphere after its kinetic energy is converted into pressure by the exhaust diffuser 31 of the exhaust chamber 30.

In the gas turbine thus configured, the clearance between the tip of each blade 28 and the side of the turbine casing 26 in the turbine 13 is a clearance which takes into account thermal elongation of the blades 28, the turbine casing 26, etc., and it is desirable that the clearance between the tip of each blade 28 and side of the turbine casing 26 in the turbine 13 is as small as possible from the viewpoint of a decrease in driving force recovery efficiency of the turbine 13 and ultimately of performance deterioration of the gas turbine itself.

In this embodiment, therefore, the initial clearance between the tip of the blade 28 and the side of the turbine casing 26 is increased and the side of the turbine casing 26 is properly cooled, so that the clearance between the tip of the blade 28 and the side of the turbine casing 26 during steady operation can be reduced to prevent a decrease in driving force recovery efficiency of the turbine 13.

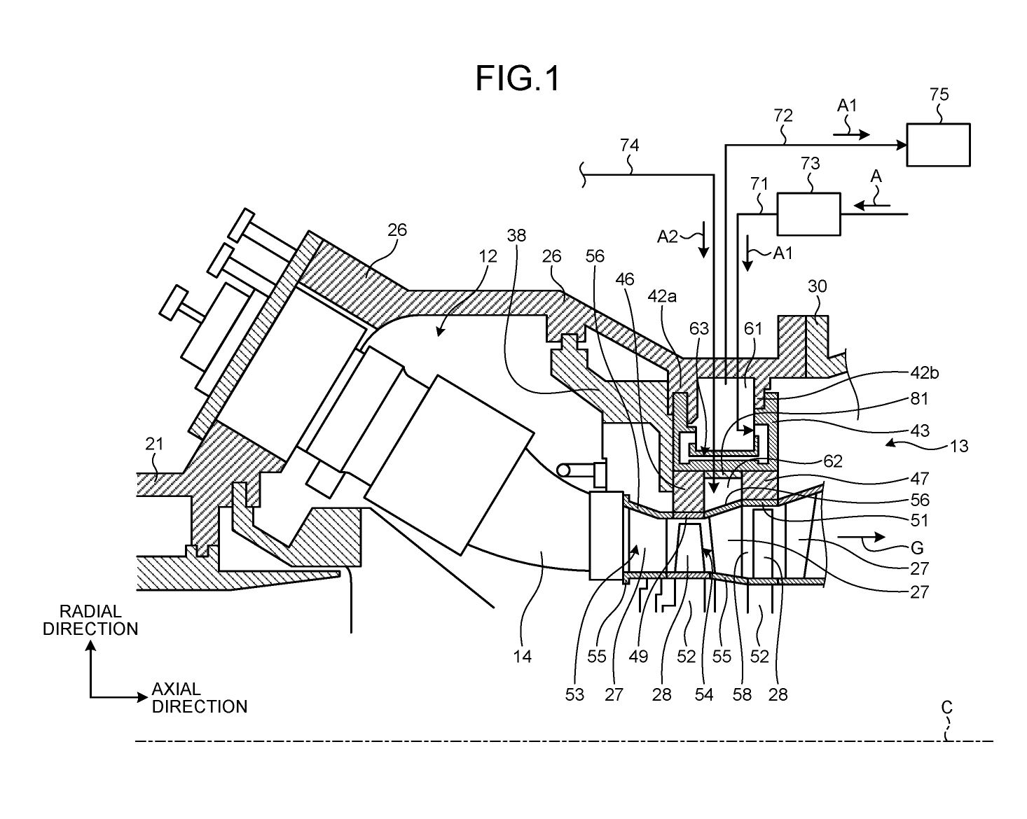

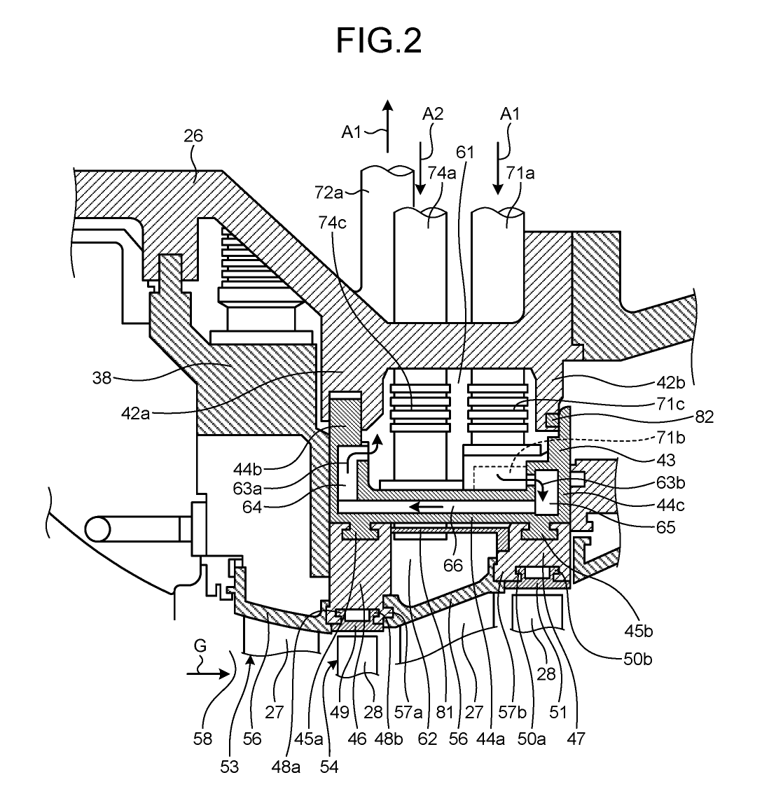

FIG. 1 is a cross-sectional view showing the vicinity of the combustor in the gas turbine of this embodiment, and FIG. 2 is a cross-sectional view showing the vicinity of a blade ring of the turbine.

As shown in FIG. 1 and FIG. 2, in the turbine 13, the turbine casing 26 has a cylindrical shape, and the exhaust casing 29 having a cylindrical shape is coupled to the turbine casing 26 on the downstream side in the flow direction of the combustion gas G. This exhaust casing 29 is provided with the exhaust chamber 30 (exhaust diffuser 31) having a cylindrical shape on the downstream side in the flow direction of the combustion gas G, and the exhaust chamber 30 is provided with an exhaust duct (not shown) on the downstream side in the flow direction of the combustion gas G.

Inner circumferential flanges 42a, 42b are integrally formed on the inner circumference of the turbine casing 26, at a predetermined interval on the front and rear sides in the flow direction of the combustion gas G, and a blade ring 43, which forms the shape of a ring divided into halves around the rotor 32, is fixed on the radially inner circumference of these inner circumferential flanges 42a, 42b. This blade ring 43 is fastened with bolts at its parting sections in the circumferential direction to form a cylindrical structure. The blade ring 43 has a cylindrical part 44a extending along the flow direction of the combustion gas G (the axial direction of the rotor 32), and a first outer circumferential flange 44b and a second outer circumferential flange 44c which are provided respectively at the ends of the cylindrical part 44a on the axially upstream side and downstream side.

The blade ring 43 has engaging portions 45a, 45b integrally formed along the circumferential direction on its inner circumference on the radially inner side, at a predetermined interval on the front and rear sides in the flow direction of the combustion gas G. A first heat shield ring 46 is supported through the engaging portion 45a from the inner circumference of the blade ring 43, and a second heat shield ring 47 is supported through the engaging portion 45b from the inner circumference of the blade ring 43. These heat shield rings 46, 47 form a ring shape around the rotor 32. A first ring segment 49 is supported on the inner circumference of the first heat shield ring 46 through engaging portions 48a, 48b, and a second ring segment 51 is supported on the inner circumference of the second heat shield ring 47 through engaging portions 50a, 50b.

The heat shield rings 46, 47, the vanes 28, 29, and the ring segments 49, 51 are divided into a plurality of parts in the circumferential direction, and are disposed in a ring shape while keeping a certain clearance.

The rotor 32 (see FIG. 7) has a plurality of discs 52 integrally coupled to its outer circumference, and is rotatably supported on the turbine casing 26 by the bearing 34 (see FIG. 7).

A plurality of vane bodies 53 and a plurality of blade bodies 54 are installed on the radially inner side of the blade ring 43, alternately along the flow direction of the combustion gas G. The vane bodies 53 have the plurality of vanes 27 disposed at regular intervals in the circumferential direction. On the radially inner side, the vanes 27 are fixed on an inner shroud 55 forming a ring shape around the rotor 32, and on the radially outer side, the vanes 27 are fixed on an outer shroud 56 forming a ring shape around the rotor 32. The vane bodies 53 have the outer shroud 56 supported on the heat shield rings 46, 47 through engaging portions 57a, 57b.

The blade bodies 54 have the plurality of blades 28 disposed at regular intervals in the circumferential direction, and the base ends of the blades 28 are fixed on the outer circumference of the disc 52. A tip portion of the blade 28 extends toward the ring segments 49, 51 disposed on the radially outer side so as to face the blade 28. In this case, a predetermined clearance is secured between the tip of each blade 28 and the inner circumferential surface of the ring segments 49, 51.

In the turbine 13, a gas path 58 which forms a ring shape around the rotor 32 and through which the combustion gas G flows is formed between the ring segments 49, 51 and the outer shroud 56 on one side and the inner shroud 55 on the other side. In this gas path 58, the plurality of vane bodies 53 and the plurality of blade bodies 54 are installed alternately along the flow direction of the combustion gas G.

The plurality of combustors 12 are disposed on the radially outer side of the rotor 32 at predetermined intervals along the circumferential direction, and are supported on the turbine casing 26 through a combustor support member 38. These combustors 12 supply fuel to high-temperature high-pressure compressed air compressed in the compressor 11 and combust the fuel to generate the combustion gas G. Outlets 14 (transition pieces) of the combustors 12 are coupled to the gas path 58.

In the turbine 13, the blade ring 43 is coupled to the inner circumferential flanges 42a, 42b of the turbine casing 26 through the first outer circumferential flange 44b and the second outer circumferential flange 44c. As a result, a first cavity 61 is defined which is adjacent to the radially outer surface of the blade ring 43, surrounded by the radially inner circumferential surface of the turbine casing 26 and the radially outer circumferential surface of the blade ring, and disposed in a ring shape around the rotor 32. In the turbine 13, the ring segments 49, 51 are fixed on the inner circumference of the blade ring 43 through the heat shield rings 46, 47, and the outer shroud 56 of the vane bodies 53 is fixed between the heat shield rings 46, 47 in the axial direction of the rotor 32. As a result, a second cavity 62 is defined which is adjacent to the radially inner circumferential surface of the blade ring 43, surrounded by the radially inner circumferential surface of the blade ring 43 and the radially outer circumferential surface of the ring segment 56, and disposed in a ring shape around the rotor 32.

As shown in FIG. 2, while the first outer circumferential flange 44b is fixed on the inner circumferential flange 42a of the turbine casing 26 in the axial direction of the rotor 32, the blade ring 43 is slidable in the radial direction. While the inner circumferential flange 42b butts against the second outer circumferential flange 44c through a seal member 82, the inner circumferential flange 42b is slidable in the radial direction. Thus, this structure makes it possible to seal the gap between the first cavity 61 and the space on the axially downstream side while absorbing shifts in the axial and radial directions of the turbine casing 26 and the blade ring 43. Owing to such a structure, the blade ring 43 is not restrained by the turbine casing 26 from shifting in the radial direction.

The turbine 13 is provided with a cooling air flow passage 63 inside the blade ring 43. This cooling air flow passage 63 has a plurality of (in this embodiment, two) manifolds 64, 65 which are disposed at a predetermined interval in the flow direction of the combustion gas G (the axial direction of the rotor 32) and formed in a ring shape around the rotor 32, and coupling paths 66 which are disposed in series with the plurality of manifolds 64, 65 in the axial direction of the rotor 32 and coupled to the manifolds 64, 64 at both ends.

Specifically, as the cooling air flow passage 63, the first manifold 64 formed as a cavity in the first outer circumferential flange 44b and the second manifold 65 formed as a cavity in the second outer circumferential flange 44c are provided. The manifolds 64, 65 each form a ring shape around the rotor 32, and these first manifold 64 and second manifold 65 are coupled with each other by the coupling paths 66 which are formed as a plurality of communication holes in the cylindrical part 44a. The plurality of communication holes constituting the coupling paths 66 are disposed at regular intervals in the circumferential direction. In a cross-sectional view from the axial direction of the rotor 32, the coupling paths 66 may be disposed in a single row or a plurality of rows in the radial direction.

The turbine 13 is provided with a first cooling air supply channel 71 which supplies cooling air A1 from the outside of the turbine casing 26 to the first cavity 61 or the cooling air flow passage 63, and a cooling air discharge channel 72 which discharges the cooling air A1 from the first cavity 61 or the cooling air flow passage 63. The cooling air flow passage 63 has one end 63a communicating with the first cavity 61 and the other end 63b coupled to the first cooling air supply channel 71. The first cooling air supply channel 71 is a pipe 71a which penetrates the turbine casing 26 from the outside, and is provided with an auxiliary cavity 71b at the leading end connected with the blade ring 43. The auxiliary cavity 71b has an annular shape in the circumferential direction and communicates with the one end 63a of the cooling air flow passage 63. The base end of the first cooling air supply channel 71 on the radially opposite side from the leading end is extended to the outside of the turbine 13 (turbine casing 26), and a fan (blower) 73 is mounted at the upstream end of the pipe 71a. The cooling air discharge channel 72 is also a pipe 72a which penetrates the turbine casing 26 from the outside of the turbine casing 26, and the leading end of the pipe 72a communicates with the first cavity 61. The pipe 71a is provided with a bellows 71c between the blade ring 43 and the turbine casing 26. While not shown, the pipe 72a is also provided with a bellows between the blade ring 43 and the turbine casing 20. The bellows 71a, 72a function to absorb differences in thermal elongation mainly in the axial direction.

The turbine 13 is further provided with a second cooling air supply channel 74 which supplies cooling air A2 to the second cavity 62. The base end of this second cooling air supply channel 74 is coupled to the bleed air chamber 25 (see FIG. 7) in an intermediate stage (an intermediate-pressure stage or a high-pressure stage) of the compressor 11, and the leading end communicates with the second cavity 62. The second cooling air supply channel 74 is a pipe 74a which penetrates the turbine casing 26 from the outside of the turbine casing 26, and this pipe 74a is provided with a bellows 74c between the blade ring 43 and the turbine casing 20. The function of the bellows 74c is the same as the bellows 71a.

In this case, the second cooling air supply channel 74 supplies a part of the compressed air compressed by the compressor 11 as the cooling air A2 to the second cavity 62. The cooling air A2 is used for cooling mainly around the vanes. Since the cooling air A2 is finally discharged into the combustion gas G flowing through the gas path 58, a relatively high pressure like that of bleed air is required. On the other hand, the first cooling air supply channel 71 supplies external air by means of the fan 73 as the cooling air A1 to the cooling air flow passage 63. In this case, it is necessary that the first cooling air supply channel 71 supplies the cooling air A1, which has a lower temperature than the cooling air A2 supplied to the second cavity 62, to the cooling air flow passage 63.

That is, to reduce the clearance between the inner circumferential surface of the ring segment 49 and the tip of the blade 28, it is desirable to maintain the blade ring 43 at as low a temperature as possible, and it is most preferable that the first cooling air supply channel 71 supplies the cooling air A1, which is atmospheric air A suctioned by means of the fan 73, to the first cavity 61 or the cooling air flow passage 63. However, the first cooling air supply channel 71 may supply the compressed air, which is extracted from a low-pressure stage of the compressor 11 at a lower pressure than the second cooling air supply channel 74, as the cooling air A1 to the first cavity 61 or the cooling air flow passage 63. In this case, too, it is preferable that the air is extracted from a low-pressure stage at a low temperature in which bleed air has a temperature closer to an atmospheric temperature.

The cooling air discharge channel 72 introduces the cooling air A1 discharged from the first cavity 61 into an exhaust cooling system 75. This exhaust cooling system 75 is, for example, the exhaust diffuser 31 provided in the exhaust chamber 30.

In the exhaust chamber diffuser 31, the cooling air supplied to the exhaust cooling system 75 cools struts 35 and the bearing 34, and is thereafter discharged into the combustion gas which flows inside the exhaust chamber diffuser 31 and is at a negative pressure before recovering its pressure. The cooling air A1 having been pressurized by the fan 73 and supplied to the turbine 13 cools around the blade ring 43, and is thereafter supplied via the discharge air supply channel 72 to the exhaust chamber diffuser 31 to cool the interior thereof. Thus, the cooling air A1 is recycled and effective utilization of the cooling air is achieved.

Since the recycled cooling air A1 is discharged into the combustion gas at a negative pressure inside the exhaust chamber diffuser 31, the discharge pressure of the fan 73 suctioning the atmospheric air A may be a relatively low pressure. Accordingly, compared with the case where bleed air of the compressor 11 is used as the cooling air A1, the method using the cooling air A1 by means of the fan 73 incurs less energy loss, so that deterioration of the gas turbine performance can be suppressed.

The turbine 13 is provided with a heat shield member 81 on the inner circumferential surface of the blade ring 43 on the side of the second cavity 62. The heat shield member 81 is divided into a plurality of parts in the circumferential direction so as to form a ring shape, and covers the radially inner circumferential surface of the blade ring 43.

The combustor support member 38, with which the first outer circumferential flange 44b of the blade ring 43 is in contact on the upstream side in the axial direction of the rotor 32, functions as the heat shield member 81 which blocks heat input from the side of the combustor 12 into the blade ring 43.

The heat shield rings 46, 47 are composed of a material having a higher thermal expansion rate (thermal expansion coefficient) than the blade ring 43. For example, the heat shield rings 46, 47 are formed of an austenitic stainless steel (SUS310S), while the blade ring 43 is formed of a 12% chrome steel.

Differences from the conventional technology in the method of cooling around the blade ring 43 will be specifically described below. As described above, the blade ring 43 has the radially outer circumferential surface in contact with the first cavity 61 and the radially inner circumferential surface in contact with the second cavity 62. The ring segments 49, 51, which are in contact with the gas path 58 where the combustion gas G flows, are supported by the heat shield rings 46, 47, and the heat shield rings 46, 47 are supported by the blade ring 43.

If the first cavity 61 is supplied with the cooling air A1 pressurized by the fan 73, and the second cavity 62 is supplied with the cooling air A2 extracted from the compressor 11, the temperature of the blade ring 43 becomes an intermediate temperature between the temperature of the cooling air A1 supplied to the first cavity 61 and the temperature of the cooling air A2 supplied to the second cavity 62. That is, heat input from the combustion gas G flowing through the gas path 58 is transmitted from the ring segments 49, 51 through the heat shield rings 46, 47 to the blade ring 43. However, the blade ring 43 itself is not in contact with the combustion gas. Therefore, the temperature of the blade ring 43 is dominated by the temperature of the cooling air A1 of the first cavity 61 and the cooling air A2 of the second cavity 62, with both of which the blade ring 43 is in direct contact, while the influence of the heat input transmitted from the combustion gas G through the ring segments 49, 51 and the heat shield rings 46, 47 is minor.

On the other hand, the ring segments 49, 51 are subjected to the heat of the combustion gas G from the gas path 58. Accordingly, although the ring segments 49, 51 and the heat shield rings 46, 47 are in contact with the second cavity 62 and cooled by the cooling air A2, they reach a high temperature compared with the blade ring 43.

Therefore, suppose that the gas turbine load has increased and the temperature of the combustion gas G has risen, the blade ring 43 shifts toward the radially outer side, while the ring segments 49, 51 and the heat shield rings 46, 47, which are supported from the inner circumferential surface of the blade ring 43 toward the radially inner side, shift toward the radially inner side relative to the blade ring 43. As a result, when seen from the center of the rotor 32, the amount of shift of the ring segments 49, 51 toward the radially outer side is smaller than the amount of shift of the blade ring 43 toward the radially outer side. On the other hand, compared with the blade ring 43, the ring segments 49, 51 and the heat shield rings 46, 47 increase in temperature under the thermal influence of the side of the combustion gas G as described above. Accordingly, the amount of shift of the inner circumferential surfaces of the ring segments 49, 51 toward the radially outer side becomes even smaller.

In the case of the structure of the turbine 13 in this embodiment, the temperature of the cooling air A1 flowing through the first cavity 61 is set to be lower than the temperature of the cooling air A2 flowing through the second cavity 62. Accordingly, a difference occurs in thermal elongation in the radial direction between the blade ring 43 on one side and the blade rings 49, 51 and the heat shield rings 46, 47 on the other side due to the temperature difference, so that the amount of shift of the inner circumferential surfaces of the ring segments 49, 51 toward the radially outer side is smaller than the amount of shift of the blade ring 43 toward the radially outer side. That is, if the temperature of the cooling air A1 supplied to the first cavity 61 and the temperature of the cooling air A2 supplied to the second cavity 62 are differentiated from each other and the blade ring 43 is kept at a low temperature, it becomes easier to control the clearance between the tip of the blade and the ring segment, so that a proper amount of clearance is maintained during rated operation and the gas turbine performance is enhanced.

The blade ring 43 may be further provided with the cooling air flow passage 63. If the cooling air flow passage 63 is provided inside the blade ring 43 and the cooling air A1 is supplied to the cooling air flow passage 63, the blade ring 43 can be kept at an even lower temperature. That is, during gas turbine operation, the atmospheric air A is supplied as the cooling air A1 by means of the fan 73 through the first cooling air supply channel 71 to the cooling air flow passage 63, and the cooling air A1 is supplied from this cooling air flow passage 63 to the first cavity 61. That is, in the blade ring 43, the cooling air A1 is supplied to the second manifold 65 and flows through the coupling paths 66 to be supplied to the first manifold 64 and then supplied to the first cavity 61. Accordingly, as the blade ring 43 is cooled by the cooling air A1 circulating inside and the cooling air A1 supplied to the outer side (first cavity 61), the blade ring 43 is prevented from reaching a high temperature. In this cooling air flow passage 63, since the path cross-sectional area of the coupling path 66 is smaller than the path cross-sectional areas of the manifolds 64, 65, the cooling air increases in flow velocity while passing through the coupling path 66, so that the blade ring 43 is cooled effectively.

In this case, since the cooling air A1 is supplied to the cooling air flow passage 63 inside the blade ring 43, the temperature of the blade ring 43 can be maintained at an even lower temperature than in the embodiment described above in which the outer circumferential surface and the inner circumferential surface of the blade ring 43 are cooled without the cooling air flow passage 63 being provided. Accordingly, the shift of the blade ring 43 toward the radially outer side becomes even smaller, which makes it easier to control the clearance between the tip of the blade and the ring segment.

On the other hand, a part of the compressed air extracted from the compressor 11 is supplied as the cooling air A2 through the second cooling air supply channel 74 to the second cavity 62. Then, this cooling air A2 passes through the vanes 27 and the inside of the shrouds 55, 56 of the vane bodies 53 and is discharged to the gas path 58 from a disc cavity (not shown), and thereby cools the vane bodies 53.

Since the blade ring 43 is provided with the heat shield member 81 on its radially inner circumferential surface on the side of the second cavity 62, the blade ring 43 is hardly subjected to heat from the cooling air A2 supplied to the second cavity 62, and therefore prevented from reaching a high temperature. That is, as described above, while the temperature of the blade ring 43 is kept at an intermediate temperature between the temperature of the cooling air A1 flowing inside the first cavity 61 and the temperature of the cooling air A2 flowing inside the second cavity 62, if the heat shield member 81 is provided on the inner circumferential surface of the blade ring 43, heat input from the side of the second cavity 62 is blocked, so that the temperature of the blade ring 43 approaches the temperature of the cooling air A1 in the first cavity 61. Accordingly, it becomes easier to control the clearance between the tip of the blade 28 and the ring segments 49, 51.

In the above embodiment, the cooling air A1 is supplied through the first cooling air supply channel 71 to the cooling air flow passage 63, and supplied from the cooling air flow passage 63 to the first cavity 61 to cool the blade 43. Moreover, the cooling air A1 of the first cavity 61 having cooled the blade ring 43 is supplied through the cooling air discharge channel 72 to the exhaust cooling system 75 of the turbine 13. However, the flow of the cooling air A1 may be reversed.

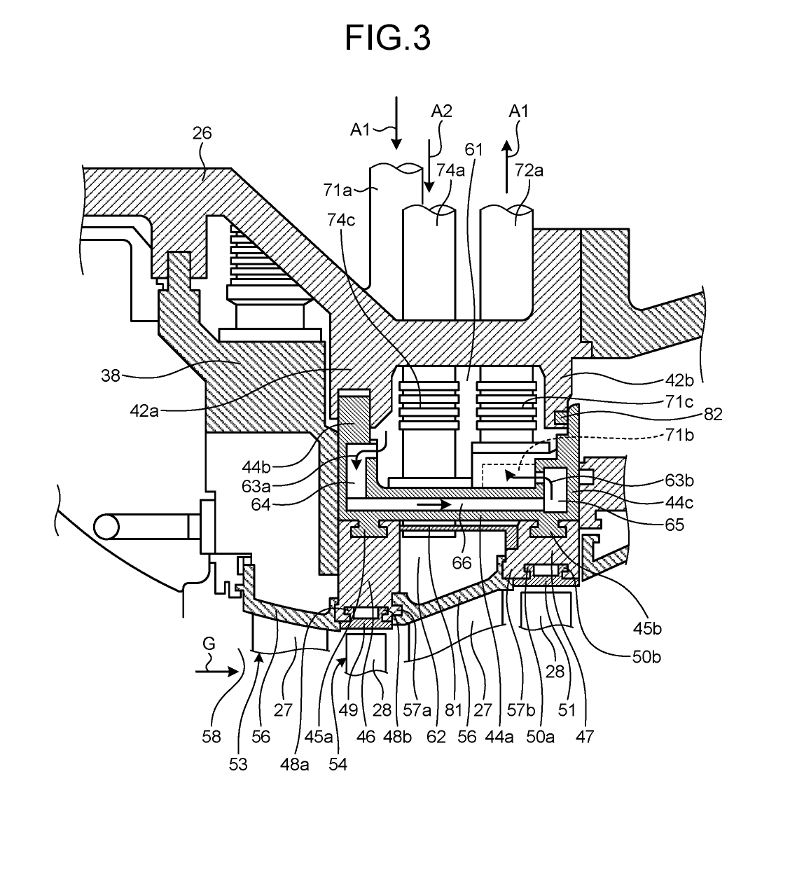

FIG. 3 is a cross-sectional view of the vicinity of a blade ring of a turbine showing a modified example of the embodiment. As shown in FIG. 3, the atmospheric air A is supplied by means of the fan 73 as the cooling air A1 through the first cooling air supply channel 71 to the first cavity 61, and the cooling air A1 is supplied from the first cavity 61 to the cooling air flow passage 63. That is, in the blade ring 43, the cooling air A1 is supplied to the first cavity 61, supplied from this first cavity 61 to the first manifold 64, and supplied through the coupling paths 66 to the second manifold 65. In this configuration, too, as the blade ring 43 is cooled by the cooling air A1 flowing inside and the cooling air A1 supplied to the radially outer side (first cavity 61), the blade ring 43 is prevented from reaching a high temperature. Then, the cooling air A1 having cooled the blade ring 43 is supplied from the cooling air flow passage 63 through the cooling air discharge channel 72 to the exhaust cooling system 75 of the turbine 13.

In FIG. 3, the other end 63b of the cooling air flow passage 63 may communicate with the first cavity 61, and one of the first cooling air supply channel 71 and the cooling air discharge channel 72 may be coupled to the cooling air flow passage 63, while the other one may communicate with the first cavity 61.

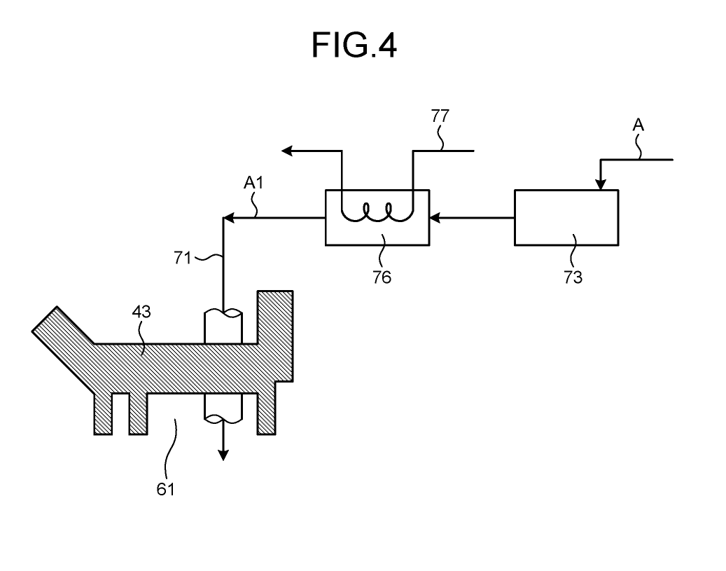

Next, FIG. 4 is a view showing an example of the first cooling air supply channel 71 which is a further modification of the embodiment shown in FIG. 1 and FIG. 2 and the modified example shown in FIG. 3. As shown in FIG. 4, the first cooling air supply channel 71 is provided with a heating device 76, which heats the cooling air A1, on the pipe route in front of the point of connection with the turbine casing 26 on the downstream side of the fan 73. As a heating medium 77, combustion exhaust gas discharged from the gas turbine, casing air at the compressor outlet, exhaust steam of a GTCC, etc. can be utilized.

Normally, the first cooling air supply channel 71 takes in the atmospheric air A and supplies the atmospheric air A as low-temperature cooling air, without heating it, to the gas turbine. However, during start of the gas turbine, the heating medium 77 may be supplied to the heating device 76 to heat the cooling air A1. If the cooling air A1 is heated, the temperature of the blade ring 43 rises and the clearance between the tip of the blade and the ring segment during start of the gas turbine can be enlarged, so that the pinch point which is likely to occur during start can be reliably avoided.

Here, the radial shift of the constituent members of the turbine 13 during start of the gas turbine will be described.

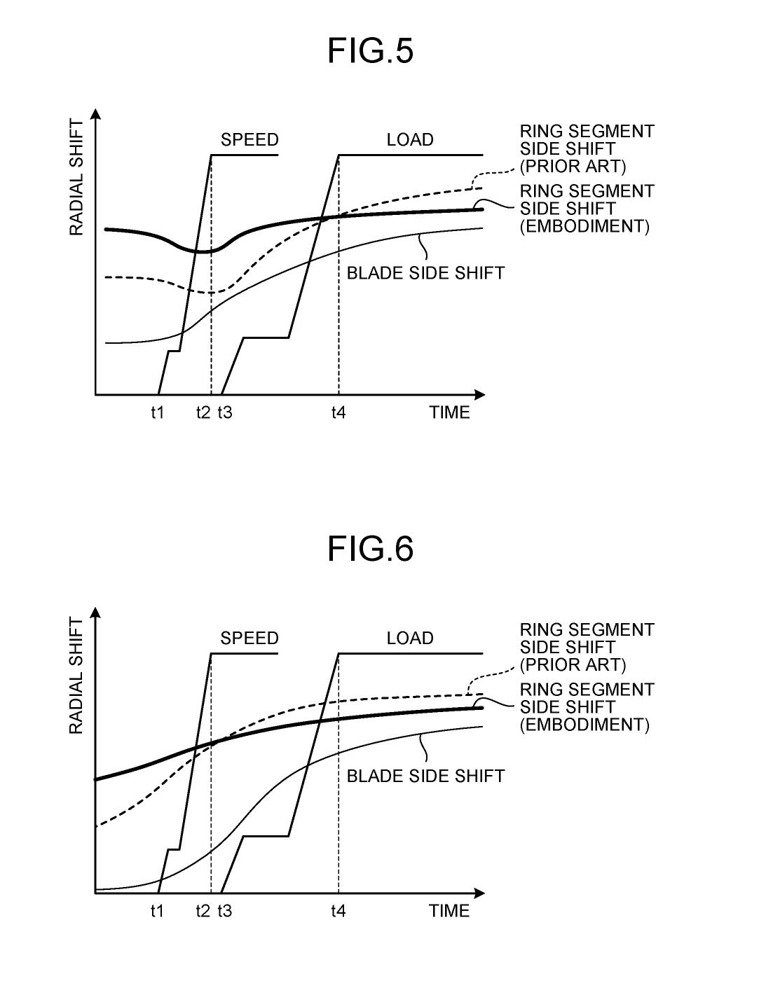

FIG. 5 is a graph showing the behavior of the clearance between the constituent members of the turbine during hot start of the gas turbine, and FIG. 6 is a view showing the behavior of the clearance between the constituent members of the turbine during cold start of the gas turbine.

In the hot start of the conventional gas turbine, as shown in FIG. 1 and FIG. 5, if a gas turbine 1 is started at time t1, the speed of the rotor 32 increases, and the speed of the rotor 32 reaches a rated speed at time t2 and is maintained constantly. Meanwhile, the compressor 11 takes in air through the air inlet 20, and as the air is compressed by passing through the pluralities of vanes 23 and blades 24, high-temperature high-pressure compressed air is generated. The combustor 12 is ignited before the speed of the rotor 32 reaches the rated speed, and supplies fuel to the compressed air and combusts the fuel to generate high-temperature high-pressure combustion gas. In the turbine 13, the combustion gas passes through the pluralities of vanes 27 and blades 28 and thereby drives the rotor 32 to rotate. As a result, the load (output) of the gas turbine increases at time t3, and reaches a rated load (rated output) at time t4 and maintained constantly.

During such hot start of the gas turbine, the blades 28 shift (elongate) toward the radially outer side as they rotate at a high speed, and then further shift (elongate) toward the outer side by being subjected to heat from the high-temperature high-pressure combustion gas G passing through the gas path 58. On the other hand, while the blade ring 43 is at a high temperature immediately after stop, for a certain time immediately after start of the gas turbine 1, the low-temperature bleed air (cooling air A2) is supplied from the compressor 11 to the blade ring 43, and the blade ring 43 is cooled temporarily. As a result, the blade ring 43 temporarily shifts (contracts) toward the radially inner side, and then, as the temperature of the bleed air from the compressor 11 rises and the cooling effect of the bleed air on the blade ring 43 diminishes, the blade ring 43 shifts (elongates) again toward the outer side.

In this case, in the conventional gas turbine, the ring segments and the heat shield rings as indicated by the dashed line in FIG. 5 shift toward the inner side by being temporarily cooled with the low-temperature bleed air at around time t2, so that the pinch point (minimum clearance) occurs at which the clearance between the tip of the blade and the inner circumferential surface of the ring segment temporarily significantly decreases. Thereafter, the ring segments, the heat shield rings, and the blade ring are heated by the high-temperature high-pressure combustion gas and the bleed air, and shift (elongate) toward the outer side. Then, during rated operation after time t4, as the ring segments, the heat shield rings, and the blade ring shift significantly toward the outer side, the clearance between the tip of the blade and the inner circumferential surface of the blade ring increases excessively.

By contrast, in the gas turbine of this embodiment, although the ring segments 49, 51 as indicated by the solid line in FIG. 5 shift toward the inner side as the ring segments 49, 51, the heat shield rings 46, 47, and the blade ring 43 are cooled with the low-temperature cooling air (the cooling air A1 and the cooling air A2) at time t2, the clearance between the tip of the blade 28 and the inner circumferential surfaces of the ring segments 49, 51 do not decrease so much as in the conventional structure, since a large clearance is secured between the tip of the blade 28 and the inner circumferential surfaces of the ring segments 49, 51 before start of the gas turbine. Then, during rated operation after time t4, the blade ring 43 is cooled by the cooling air (cooling air A1) supplied to the first cavity 61 and the cooling air flow passage 63, while heat input from the compressed air of the second cavity 62 is suppressed by the heat shield member 81. As a result, although the blade ring 43 shifts slightly toward the outer side, the clearance between the tip of the blade 28 and the inner circumferential surfaces of the ring segments 49, 51 or the inner circumferential surface of the heat shield member 81 does not become so large as in the conventional structure.

As shown in FIG. 1 and FIG. 6, during cold start of the gas turbine, since the ring segments do not shift toward the radially inner side compared with during hot start, the pinch point is even less likely to occur than during hot start.

Thus, the gas turbine of this embodiment has the compressor 11, the combustors 12, and the turbine 13. The turbine 13 is composed of the turbine casing 26, the rotor 32 rotatably supported in a center part of the turbine casing 26, the blade ring 43 which is supported on the radially inner circumference of the turbine casing 26 and defines the ring-shaped first cavity 61 which receives low-temperature cooling air, the plurality of blade bodies 54 fixedly disposed on the outer circumference of the rotor 32 at predetermined intervals in the axial direction, and the plurality of vane bodies 53 which are disposed alternately between the plurality of blade bodies 54 in the axial direction of the rotor and have the ring-shaped second cavity 62 formed on the radially outer circumferential side. The blade ring 43 includes the plurality of heat shield rings 46, 47 supported on the radially inner circumference of the blade ring 43 at a predetermined interval in the axial direction, and the plurality of ring segments 49, 51 supported on the radially inner circumference of the plurality of heat shield rings 46, 47. Moreover, the turbine 13 is provided with the cooling air discharge channel 72 which discharges cooling air from the first cavity 61, and the second cooling air supply channel 74 which supplies compressed air to the second cavity 62.

Accordingly, a part of the compressed air is extracted from the compressor 11, and the extracted compressed air is supplied as the cooling air A2 through the second cooling air supply channel 74 to the second cavity 62, while the cooling air A1 is supplied through the first cooling air supply channel 71 to the first cavity 61, and the cooling air A1 is discharged from the first cavity 61 through the cooling air discharge channel 72. That is, as the cooling air A1 having a lower temperature than the cooling air A2 is supplied to the first cavity 61, it is possible to reduce the radial shift of the blade ring and suppress the radial shift of the ring segments 49, 51. As a result, it is possible to suppress a decrease in driving force recovery efficiency of the turbine 13 and enhance the gas turbine performance by maintaining a proper amount of clearance between the ring segments 49, 51 and the blade 28.

In the gas turbine of this embodiment, the heat insulation/shield member 81 is provided on the inner circumferential surface of the blade ring 43. Accordingly, since heat input from the second cavity 62 into the blade ring 43 is blocked by the heat shield member 81, the blade ring 43 is prevented from reaching a high temperature.

In the gas turbine of this embodiment, as the cooling air flow passage 63, the plurality of manifolds 64, 65 disposed at a predetermined interval in the axial direction of the rotor 32, and the coupling paths 66 coupling the plurality of manifolds 64, 65 in series are provided. Accordingly, as the cooling air A1 flows between the plurality of manifolds 64, 65 through the coupling paths 66 inside the blade ring 43, the blade ring 43 can be cooled efficiently.

In the gas turbine of this embodiment, as the blade ring 43, the cylindrical part 44a extending along the axial direction of the rotor 32, and the first outer circumferential flange 44b and the second outer circumferential flange 44c provided respectively at the ends of the cylindrical part 44a on the axially upstream side and downstream side are provided, and the plurality of manifolds 64, 65 are formed as cavities in the first outer circumferential flange 44b and the second outer circumferential flange 44c. In addition, the coupling paths 66 are formed as the plurality of communication holes in the cylindrical part 44a. Accordingly, the cooling air A1 flows through the communication holes, which serve as the coupling paths 66, between the plurality of manifolds 64, 65, and as the cooling air A1 flows throughout the interior of the blade ring 43, the blade ring 43 can be cooled efficiently.

In the gas turbine of this embodiment, the first cooling air supply channel 71 supplies the atmospheric air A by means of the fan 73 to the cooling air flow passage 63 and the first cavity 61. Accordingly, as the atmospheric air A is supplied to the cooling air flow passage 63 and the first cavity 61, it is possible to easily cool the blade ring 43 with the cooling air A1 in a simple configuration. Moreover, since atmospheric air is taken in and the low-temperature low-pressure cooling air A1 can be supplied to the first cavity 61 by means of the fan 73, the blade ring can be maintained at a low temperature, which makes it easy to control the clearance of the ring segments. Furthermore, being able to use low-pressure air has double advantages in that the power for the fan can be reduced and that energy loss of the gas turbine can be suppressed.

In the gas turbine of this embodiment, the heat shield rings 46, 47 are composed of a material having a higher thermal expansion rate than the blade ring 43. Accordingly, since the heat shield rings 46, 47 are heated by the combustion gas G and thermally expand, the clearance between the ring segments 49, 51 and the blade 28 during rated operation of the gas turbine can be set to a smaller amount.

In the gas turbine of this embodiment, since the heating device 76 is provided in the first cooling air supply channel 71, the occurrence of the pinch point during start of the gas turbine can be reliably avoided.

In the gas turbine of this embodiment, the cooling air discharge channel 72 introduces the cooling air A1 discharged from the first cavity 61 into the exhaust cooling system 75, and the cooling air A1 is discharged into the combustion gas at a negative pressure in the exhaust diffuser 31. Accordingly, since the cooling air A1 having cooled the blade ring 43 is introduced through the cooling air discharge channel 72 into the exhaust cooling system 75, the cooling air A1 is recycled and effective utilization of the cooling air A1 can be achieved. Since the cooling air A1 is discharged into the combustion gas at a negative pressure, the discharge pressure of the fan 73 does not have to be high.

In the above-described embodiment, the cooling air flow passage 63 is configured by forming the plurality of manifolds 64, 65 and the coupling paths 66 inside the blade ring 43, but the present invention is not limited to this configuration. That is, the shapes, the numbers, the positions of formation, etc. of the manifolds 64, 65 can be set appropriately according to the shapes and the positions of the blade 28 and the blade ring 43.

### REFERENCE SIGNS LIST

11 Compressor
12 Combustor
13 Turbine
26 Turbine casing
27 Vane
28 Blade
32 Rotor (rotating shaft)
43 Blade ring
44a Cylindrical part
44b First outer circumferential flange
44c Second outer circumferential flange
46, 47 Heat shield ring
49, 51 Ring segment
53 Vane body
54 Blade body
56 Outer shroud
58 Gas path
61 First cavity
62 Second cavity
63 Cooling air flow passage
64 First manifold
65 Second manifold
66 Coupling path
71 First cooling air supply channel
72 Cooling air discharge channel
73 Fan (blower)
74 Second cooling air supply channel
75 Exhaust cooling system
76 Heating device
77 Heating medium
81 Heat shield member
82 Seal member
A Atmospheric air
A1, A2 Cooling air
C Rotation axis

1. A gas turbine comprising:
a compressor which compresses air;
a combustor which mixes compressed air compressed by the compressor and fuel and combusts the fuel;
a turbine which produces rotary power from combustion gas generated by the combustor; and
a rotating shaft which is driven by the combustion gas to rotate around a rotation axis, wherein
the turbine includes:
a turbine casing forming a ring shape around the rotation axis;
a blade ring which forms a ring shape around the rotation axis and is supported on the inner circumference of the turbine casing so as to define a ring-shaped first cavity;
a plurality of heat shield rings which form a ring shape around the rotation axis and are supported on the inner circumference of the blade ring at predetermined intervals in the axial direction;
a plurality of ring segments which form a ring shape around the rotation axis and are supported on the inner circumference of the plurality of heat shield rings;
a plurality of blade bodies which are fixed on the outer circumference of the rotating shaft at predetermined intervals in the axial direction and disposed so as to radially face the ring segments;
a plurality of vane bodies of which a shroud forming a ring shape around the rotation axis between the plurality of blade bodies is fixed on the adjacent heat shield rings so as to define a ring-shaped second cavity;
a second cooling air supply channel which supplies a part of the compressed air compressed by the compressor to the second cavity;
a first cooling air supply channel which supplies cooling air having a lower temperature than the compressed air compressed by the compressor to the first cavity; and
a cooling air discharge channel which discharges the cooling air from the first cavity.

2. A gas turbine comprising:
a compressor which compresses air;
a combustor which mixes compressed air compressed by the compressor and fuel and combusts the fuel;
a turbine which produces rotary power from combustion gas generated by the combustor; and
a rotating shaft which is driven by the combustion gas to rotate around a rotation axis, wherein
the turbine includes:
a turbine casing forming a ring shape around the rotation axis;
a blade ring which forms a ring shape around the rotation axis and is coupled on the inner circumference of the turbine casing so as to define an annular first cavity;
a plurality of heat shield rings which form a ring shape around the rotation axis and are coupled on the inner circumference of the blade ring at predetermined intervals in the axial direction;
a plurality of ring segments which form a ring shape around the rotation axis and are coupled on the inner circumference of the plurality of heat shield rings;
a plurality of blade bodies which are fixed on the outer circumference of the rotating shaft at predetermined intervals in the axial direction and disposed so as to radially face the ring segments;
a plurality of vane bodies of which a shroud forming a ring shape around the rotation axis between the plurality of blade bodies is fixed on the adjacent heat shield rings so as to define an annular second cavity;
a second cooling air supply channel which supplies a part of the compressed air compressed by the compressor to the second cavity;
a cooling air flow passage which is provided inside the blade ring and of which one end communicates with the first cavity;
a first cooling air supply channel which supplies cooling air having a lower temperature than the compressed air compressed by the compressor to one of the other end of the cooling air flow passage and the first cavity; and
a cooling air discharge channel which discharges the cooling air from the other one of the other end of the cooling air flow passage and the first cavity.

3. The gas turbine according to claim 1, wherein a heat shield member is provided on the inner circumferential surface of the blade ring.

4. The gas turbine according to claim 2, wherein the cooling air flow passage has a plurality of manifolds disposed at predetermined intervals in the axial direction of the rotating shaft, and coupling paths coupling the plurality of manifolds in series.

5. The gas turbine according to claim 2, wherein
the blade ring has a cylindrical part extending along the axial direction of the rotating shaft, and a first outer circumferential flange and a second outer circumferential flange provided respectively at both ends of the cylindrical part,
the plurality of manifolds are formed as cavities in the first outer circumferential flange and the second outer circumferential flange, and
the coupling paths are formed as a plurality of communication holes in the cylindrical part.

6. The gas turbine according to claim 1, wherein the first cooling air supply channel supplies atmospheric air suctioned by means of a blower.

7. The gas turbine according to claim 1, wherein the heat shield ring is composed of a material having a higher thermal expansion rate than the blade ring.

8. The gas turbine according to claim 1, wherein the first cooling air supply channel includes a heating device which heats the cooling air.

9. The gas turbine according to claim 1, wherein the cooling air discharge channel introduces the cooling air discharged from the first cavity into an exhaust cooling system.

10. The gas turbine according to claim 2, wherein a heat shield member is provided on the inner circumferential surface of the blade ring.

11. The gas turbine according to claim 2, wherein the first cooling air supply channel supplies atmospheric air suctioned by means of a blower.

12. The gas turbine according to claim 2, wherein the heat shield ring is composed of a material having a higher thermal expansion rate than the blade ring.

13. The gas turbine according to claim 2, wherein the first cooling air supply channel includes a heating device which heats the cooling air.

14. The gas turbine according to claim 2, wherein the cooling air discharge channel introduces the cooling air discharged from the first cavity into an exhaust cooling system.
